(19) United States
(12) Patent Application Publication
(10) Pub. No.: US 2012/0059707 A1
(43) Pub. Date: Mar. 8, 2012

(54) METHODS AND APPARATUS TO CLUSTER USER DATA

(75) Inventors: Vishal Goenka, Foster City, CA (US); Anurag Agarwal, Sunnyvale, CA (US); Arun Dev Qamra, Santa Clara, CA (US); Vassilis Papavassiliou, Oakland, CA (US); Daishi Harada, Oakland, CA (US); Rajas Moonka, San Ramon, CA (US); David Monsees, San Francisco, CA (US)

(73) Assignee: GOOGLE INC., Mountain View, CA (US)

(21) Appl. No.: 13/223,239

(22) Filed: Aug. 31, 2011

Related U.S. Application Data
(60) Provisional application No. 61/379,121, filed on Sep. 1, 2010.

(51) Int. Cl. G06Q 30/02; G06F 17/30

(52) U.S. Cl. 705/14.41; 707/737; 705/14.71; 705/14.49; 705/14.67; 707/E17.089

(57) ABSTRACT

Among other disclosed subject matter, a computer-implemented method includes receiving a first data set associated with a first data provider. The first data set includes a first set of data attributes associated with a first set of users. The method includes receiving a second data set associated with a second different data provider. The second data set includes a second set of data attributes associated with a second set of users. The method includes generating user cluster information based at least in part on at least one common data attribute associated with the first set of users and the second set of users. The method includes providing the user cluster information to a data purchaser.

### CROSS-REFERENCE TO RELATED APPLICATIONS

This application claims the benefit of priority Under 35 U.S.C. §119(e) of U.S. Provisional Application Ser. No. 61/379,121, filed on Sep. 1, 2010. The disclosure of the prior application is considered part of and is incorporated by reference in the disclosure of this application.

### BACKGROUND

This document relates to managing user data.

As an individual visits and interacts with websites, website operators (e.g., Yahoo!) and/or advertisers collect user data related to the individual. For example, the user data collected by a content publisher can include information associated with products, services or articles that the individual expressed interest in by viewing the item, clicking on the item, searching for the item, etc. In addition, the user data can include search terms, search results, data entered into fields such as a registration form, data that is inherently collected, such as time and date information and contextual data, and other data from interactions with the website, such as moving a mouse over an advertisement. The user data is collected using proprietary or arbitrary semantics.

The website operators can analyze the user data collected from users/visitors of its website and cluster the users based on similarities in the user data, such as similar browsing or shopping habits (“user clusters”). In addition, the website operators can analyze the collected user data and cluster the user data based on relationships between data attributes represented in the user data and determine relationships between the data attributes (“data clusters”). For example, an example data cluster can identify that a DSLR camera is related to an external flash because users who shop for a DSLR camera also shop for an external flash.

### SUMMARY

In one aspect, a computer-implemented method includes receiving a first data set associated with a first data provider. The first data set includes a first set of data attributes associated with a first set of users. The method includes receiving a second data set associated with a second different data provider. The second data set includes a second set of data attributes associated with a second set of users. The method includes generating user cluster information based at least in part on at least one common data attribute associated with the first set of users and the second set of users. The method includes providing the user cluster information to a data purchaser.

In another aspect, a computer implemented method includes receiving user data associated with a data provider. The user data includes a first data set associated with a first user and a second data set associated with a second user. The method includes generating data cluster information based on the co-occurrence of data in the first data set and the second data set.

In another aspect, a computer implemented method includes receiving a first user list associated with a first data provider. The first user list includes a plurality of users associated with a first set of data attributes. The method includes receiving a second user list associated with a second different data provider. The first user list includes a plurality of users associated with a second set of data attributes. The method includes determining whether the first user list is similar to the second user list. The method includes identifying the second user list as similar to the first user list if the first user list is similar to the second user list including attributing known performance data associated with the first user list to the second user list.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a block diagram of an example environment in which a data exchange system generates user and data clusters and provides performance information.

FIG. 2 is a block diagram of the data exchange system.

FIG. 3 is a flowchart of an example process for generating user clusters.

FIG. 4 is a flowchart of an example process for generating data clusters.

FIG. 5 is a block diagram of an example computer system that can be used to implement the data exchange system

Like reference symbols in the various drawings indicate like elements.

### DETAILED DESCRIPTION

Systems and methods are described for providing a centralized system for clustering user data and providing performance models. A data exchange system receives sets of user data from two or more data providers and identifies user clusters across the sets of user data. The data exchange system also can identify data cluster across the user data provided by a data provider. The user clusters and data clusters can be provided to a data purchaser/licensee that can use the clusters to improve its online advertising campaigns. The data exchange system can also receive advertisement metric information, such as the click through rate and/or the conversion rate, of an advertisement or advertisement campaign using the user clusters and generate a performance model for the user clusters. The performance model can indicate the value of the user clusters and can be used to determine the data purchaser's return on its investment in the user clusters and/or in online advertising.

In general, the data exchange system 102 receives sets of user data collected by data providers 106a and 106b and generates user clusters based on the user data collected by both data providers 106a and 106b (e.g., based on owned or permissioned data). While two data providers are shown, more are possible. The data exchange system 102 can also use the user data collected by the data provider 106a or 106b to generate data clusters. The user clusters and the data clusters can be provided to a data purchaser 108 and/or the data providers 106a and 106b. The data purchaser 108 interacts with the advertisement network 110 and the ad metric engine 112 and applies the user and data clusters to, for example, improve the effectiveness of its online advertising campaign. As the data purchaser's 108 online advertising is shown to users, the ad metric engine 112 collects advertisement performance information and provides feedback to the data exchange system 102, which analyzes the information in connection with the clusters and provides performance information to the data purchaser 108. The data purchaser 108 can use the performance information to improve the effectiveness of its advertising campaign and improve its return on investment in the user clusters and online advertising.

Advantageously, the described system may provide for one or more benefits, such as identifying user clusters across user data provided by two different data providers 106 and making the user clusters easily traded with the data purchaser 108. In addition, the described system may allow data providers 106 that do not own or otherwise have access to clustering technology to outsource the identification of user clusters or data clusters to the data exchange system 102. The described system can also allow the data purchaser 108 and the data providers 106a and 106b to accurately price its user cluster or data clusters and allow the data purchaser 108 to manage its return on investment in online advertising.

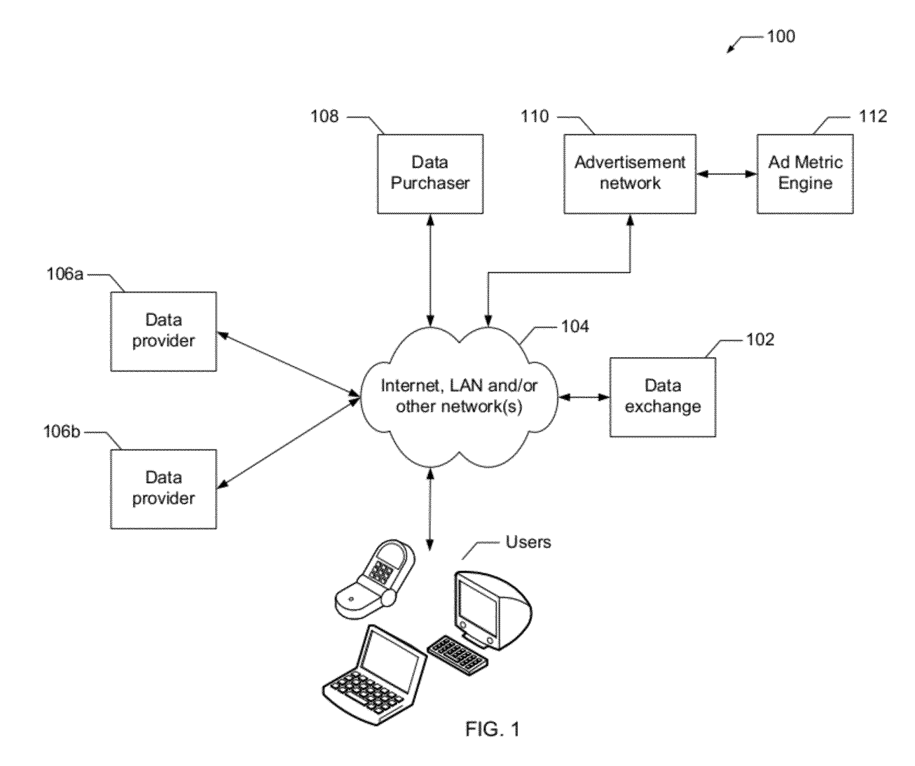

FIG. 1 is a block diagram of an example environment in which a data exchange system 102 generates user clusters and/or data clusters and provides performance information to the data purchaser 108. The example environment 100 includes the data exchange system 102, a network 104, the data providers 106a and 106b, users that interact with content, websites or advertising associated with the data providers 106a and 106b, a data purchaser 108, an advertisement network 110 and an ad metric engine 112.

The network 104 can be of the form as a local area network (LAN), wide area network (WAN), the Internet, or a combination thereof. The network 104 connects users, the data exchange system 102, the data providers 106a and 106b, the data purchaser 108, the advertisement network 110 and the ad metric engine 112.

The data providers 106a and 106b are entities, such as a content publisher or data aggregator (e.g., BlueKai), that collects user data (i.e., information associated with the user's activities on the website, information inherently collected from a website, and/or user's interactions with the advertising). For example, a data provider 106a can operate websites and/or online advertising and collect user data from users that visit the websites or interact with the advertising (e.g., moving the mouse over an interactive advertisement). As the user interacts with the website, the data provider 106a collects user data related to the products the user purchases or expresses some interest in by viewing the item, clicking on the item, searching for the item, etc. The user data can include data attributes such as the price of products and services, product names, general categories of products and/or manufacturer or brand information. In addition, the data provider 106a can collect other information, such as information related to the user's geographical location, information that is inherently collected (e.g., time and date information, IP address and website contextual information), and personal or demographic information that the user provided in registration forms (e.g., zip code, age, ethnicity, and/or hobbies).

The data providers 106a and 106b can collect the user data using various techniques, such as pixels and/or tags. Each data provider 106 can use proprietary or arbitrary semantics to represent the user data. For example, the data provider 106a can represent a price data attribute as (P1, $100) and the data provider 106b can represent the same price data attribute as (price, 100). The data providers 106a and 106b can store the user data and transmit a set of user data to the data exchange system 102 or can transmit the user data to the data exchange system 102 as it is collected.

As the data providers 106a and 106b collect a particular user's data, the data providers 106a and 106b associate the particular user's data to a unique user identification (i.e., a user ID), which is provided by data providers 106a and 106b and/or the data normalization system 102. The user ID can be associated with a cookie placed on the user's Internet-connected device (e.g., a computer, a tablet computer or a smart phone). The user ID can be used by the data exchange system 102 to identify the particular user's data associated with each data provider 106a and/or 106b. In some implementations, a cookie matching service can be used to share user IDs between the data providers 106a and 106b and the data exchange system 102.

The data purchaser 108 is an entity that purchases or subscribes to user data and/or clusters from the data providers 106a and/or 106b. For example, the data purchaser 108 can purchase user clusters and data clusters from the data providers 106a and/or 106b, can rent the user clusters and data clusters from the data providers 106a and/or 106b or can exclusively or non-exclusively license the user clusters and data cluster from the data providers 106a and/or 106b. The data purchaser 108 can use the clusters, for example, to improve the effectiveness of its online advertising campaign. For example, the data purchaser 108 can configure the advertisement network 110 to engage in a targeted advertising campaign or personalized advertisements based on the user clusters and/or data clusters. In some implementations, the data purchaser 108 can use the clusters and cluster performance information to determine an amount it will bid for advertisement placement and/or the user clusters. Other uses are possible.

In examples where the data providers 106a and 106b collect user data in proprietary or otherwise unique formats, the user data can be transformed to a common format before the data purchaser 108 receives the user data. The data purchaser 108 can specify that the user data and the user and data clusters it purchases conform to a data model that it defines. For example, the data purchaser 108 can define a data model that includes certain data attributes, excludes other data attributes and uses the data purchaser's naming convention. Using the data purchaser's custom data model, the data providers 106a and 106b interact with the data exchange system 102 to create data rules to normalize and transform the collected user data to conform to the data purchaser's custom data model.

In some implementations, the data providers 106a and 106b can specify the data model for user data provided to the data purchaser 108. For example, the data provider 106a may have capacity or technology limitations that prevent it from normalizing the user data in the manner specified by the data purchaser 108. As such, the data provider 106a can create rules that consider these limitations.

The advertisement network 110 can be any online/offline advertising or content item serving system. The data purchaser 106 can implement online advertising campaigns using the advertisement network 110 and can instruct the advertising network 112 to target certain individuals for its advertisements, to show certain content (e.g., advertisements) to particular users and to specify the amount the data purchaser 106 is willing to pay for the advertisement placement (i.e., bid amount). The advertisement network 110 is connected to an ad metric engine 112. While reference is made throughout the document to advertisements, other forms of content can be provided.

The ad metric engine 112 provides feedback to the data purchaser 108 and the data exchange system 102 related to the performance of the data purchaser 108's advertisement(s). For example, the ad metric engine 110 can provide information related to the number of clicks an advertisement receives (i.e., click through rate), the number of impressions it receives, information related to interactions with the advertisements, and the conversion rate, which can be the number of sales resulting from a user clicking on the advertisement (i.e., the click through conversion rate) or the number of sales resulting from a user viewing the advertisement (i.e., the view through conversion rate). The ad metric engine 112 can also identify the user clusters or data clusters that are associated with a particular advertisement.

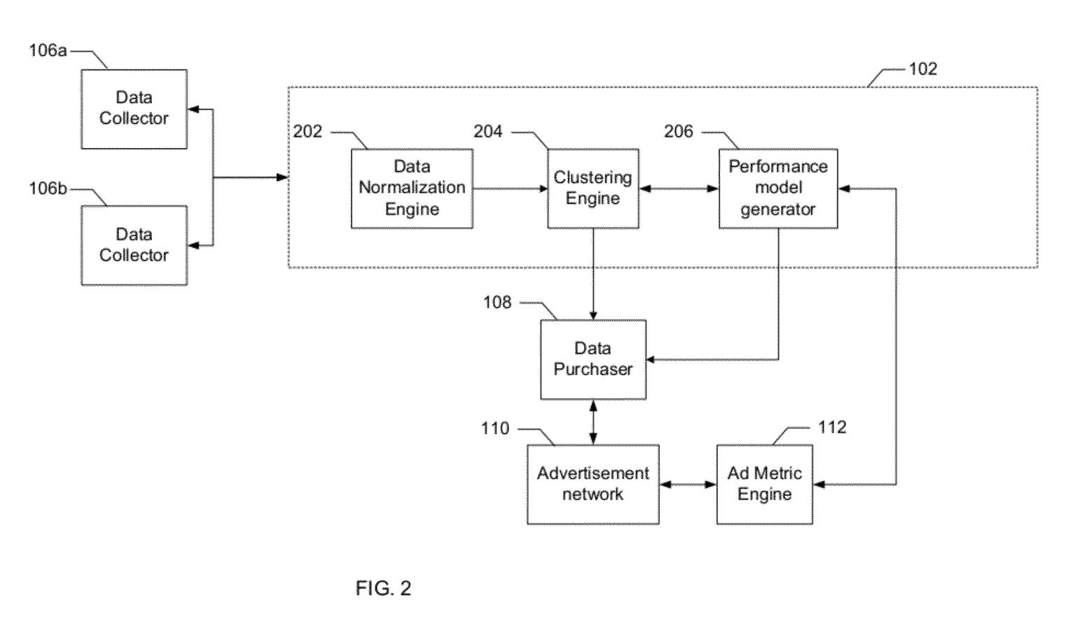

FIG. 2 is a block diagram of the data exchange system 102. In general, the data providers 106a and 106b and the data purchaser 108 can interact with the data exchange system 102, which acts as an intermediary to facilitate the buying/selling or exchange of user data, user clusters, data clusters or other information. Using the data exchange system 102, the data providers 106a and 106b can specify the price they wish to charge for their user clusters and data clusters, and the data purchaser 108 can specify the price it is willing to pay for the data provider 106a's and 106b's user clusters and data clusters. Alternatively, the price can be suggested by the data exchange system 102. The price information is stored in memory associated with the data exchange system 102. In addition, the data exchange system 102 can receive information from the advertisement network 110 and/or the ad metric engine 112 and provide the data purchaser 108 and/or the data providers 106a and 106b with information related to the user clusters' performance. The data purchaser 108 can also receive information related to its return on investment of its money spent on a particular user/data cluster. The data exchange system 102 can include a data normalization engine 202, a clustering engine 204 and a performance model generator 206.

The data normalization engine 202 receives rules created by, for example, the data providers 106a and 106b and applies the rules to transform the data providers' user data such that the transformed data conforms to the data purchaser's custom data model. The data normalization engine 202 can normalize the user data by, for example, converting the data provider's naming convention to conform to the data purchaser's naming convention. For example, if a data provider 104 represents a destination city as (DST, San Fran), the data purchaser 106 can require that DST be normalized to “Destination” and “San Fran” be normalized to “San Francisco” In some implementations, the rules can format the data such that the data provided to the data purchaser is in accordance with the data purchaser's requirements. For example, the rules can format date information to be presented as mm/dd/yyyy or dd/mm/yyyy. The data normalization engine 202 can also restructure the user data such that the transformed data includes particular user data and excludes other user data.

In addition, the data normalization engine 202 can generate customized user lists based on the transformed user data. In some implementations, user lists are a collection of user IDs that are characterized by a list definition. For example a user list can be a list of entities that share a common interest in a product or service.

The transformed data can be provided to the data purchaser 108, the data providers 106a and 106b or stored in a database or memory associated with the data exchange system 102.

The clustering engine 202 receives the transformed user data and/or user lists generated by the data normalization engine 202 and generates user clusters and/or data clusters. The user clusters can indicate similarities between users. For example, a user cluster can represent users who share similar shopping or browsing histories. The user clusters can be used to predict that a member of the user cluster will act like other members in the user cluster. The data clusters represents similarities in products, services or other data attributes captured in the user data. For example, a data cluster can represent that a fishing rod is related to a hip wader and to a tackle box because users typically shop for or have expressed interest in a combination of these items.

The clustering engine 202 can use various hierarchical or partitional algorithms to analyze and identify the co-occurrence of data attributes across the users' user data and/or similarities in the data attributes contained in the user data. For example, the clustering engine 202 can use a k-means clustering algorithm or a quality threshold (“QT”) algorithm to identify the user clusters and data clusters. The clustering engine 202 can provide the user clusters and data clusters to the data purchaser 108 and the data providers 106a and 106b.

In addition, data providers 106a and 106b and/or the data purchaser 108 can influence and/or specify how the user data is clustered. In some implementations, the data providers 106a and 106b can specify which data attributes the clustering engine 204 should analyze and the significance of each data attribute contained in the sets of user data. For example, if the data providers 106a and 106b provide sets of user data related to airline ticket sales and the data providers 106a and 106b want to identify clusters of users that are leisure travelers, the data providers 106a and 106b can instruct the clustering engine 204 that the departure and return dates are significant because travelers beginning their trip on Friday nights and returning on Sunday night are more likely to be leisure travelers. Similarly, if the data provider 106a wants to generate data clusters that identifies baseball equipment, the data provider 106a can instruct the clustering engine 204 that price is important, which can cause the clustering engine 204 to identify a baseball mitt and baseball bat as being related items because the prices of the items are similar. However, the clustering engine 204 will identify baseball cards as being different from a baseball bat and mitt because price of baseball cards is significantly lower than that of the baseball bat and mitt. In some implementations, the data providers 106a and 106b can indicate the significance of each data attribute by associating a weighting factor to the data attribute.

The performance model generator 206 can receive advertisement performance information, such as a click through rate, conversion rates and/or advertisement interaction rates, from the ad metric engine 112 or other source and can generate performance models for the user/data clusters and/or user lists. For example, the performance model generator 206 can analyze the advertisement performance information relative to the user/data clusters and/or the user lists that were used in connection with the advertisements and generate models that predict how well each user/data cluster and/or user list will perform in the future. The performance model generator 206 can provide the performance models to the ad metric engine 112 and/or advertisement network 110.

In some implementations, the performance model generator 206 uses predictive modeling to provide performance information. The performance model generator 206 can predict how a given cluster and/or a user list will perform based on previously observed performance of similar data and/or previously observed performance of similar clusters or user lists. The performance model generator 206 can be configured to use various predictive models. For example, the performance model generator 206 can be configured to use a Bayesian model to predict the performance of a user/data cluster and provide a confidence level in the predicted performance.

The ad metric engine 112 receives the performance model and provides performance information to the data purchaser 108 and data providers 106a and 106b. The performance information can include information related to how advertisements using a particular user cluster are performing and provides the data purchaser 108 and/or the data provider 106a and 106b with guidance as to the value of the clusters or the user lists. In addition, the ad metric engine 112 can provide the data purchaser 108 with its return on investment based on the cost the data purchaser 108 paid to the data provider for the clusters and the performance of the advertisement using the clusters. The ad metric engine 112 can provide reports, messages and/or other forms of feedback to the data providers 106a and 106b and data purchaser 108.

In some implementations, the data exchange system 102 can receive queries from the advertisement network 110 to determine whether a particular user is a member of a user cluster and the cost associated with purchasing/licensing the user cluster from the data provider 106a and/or 106b. The data exchange system 102 can access the price the data provider 106a and/or 106b has set for the particular user cluster and provide it to the advertisement network 110.

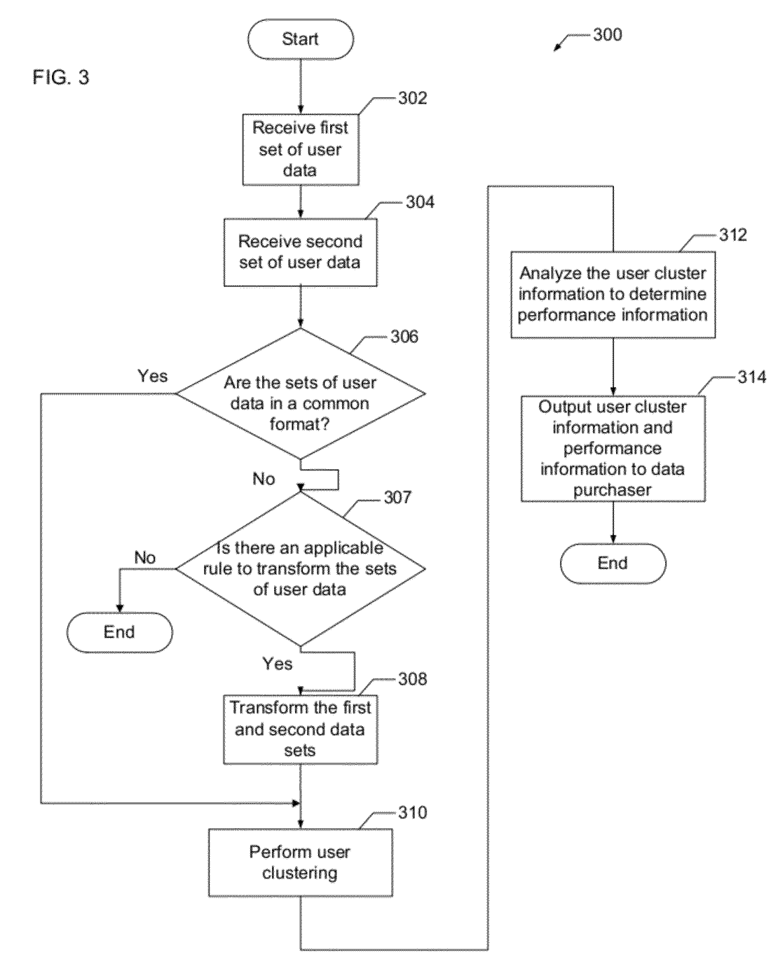

FIG. 3 is a flowchart of an example process 300 for generating user clusters. Cookies are one example of particular way that user information can be tracked and passed to the advertising system. For the purposes of these discussions, it is assumed that a cookie associated with a particular user (including the user's user ID) is resident on the user's computer. The cookie can be placed on the user's computer by for example the data provider 104 or the data exchange system 102. In addition, it is assumed that data providers 106a and 106b have created rules based on the data purchaser's custom data model. The rules can be stored by the data normalization system 202.

The example process 300 begins with the receipt of a set of user data (stage 302). For example, the data provider 106a can transmit a set of user data it collected to the data exchange system 102. The set of user data includes user data associated with a plurality of users that have interacted with content, websites and/or advertisements associated with data provider 106a. In some implementations, each user's user data is associated with his/her unique user ID associated with data provider 106a. For example, the data provider 106a can collect data associated with articles read by the user, products or services viewed by the user or otherwise expressed interest in, products searched for by the user and/or services that the user purchased. In addition, the user data can include demographic information and personal information, such as age, gender and zip code that the users provide in registration forms or otherwise provide to the data provider 106a. The data provider 106a transmits the set of user data to the data exchange system 102 using the network 104.

In some implementations, the data provider 106a transmits user data as it is collected. The data exchange system 102 can store the user data in a database or memory and associate the user data with the data provider 106a. For example, the data exchange system 102 can use a descriptor or token to indicate that the user data was collected by the data provider 106a.

At stage 304, a second set of user data is received. For example, the data provider 106b can transmit a set of user data to the data exchange system 102. The set of user data includes user data associated with a plurality of users that have interacted with content, websites and/or advertisements associated with the data provider 106b. Each user's user data is associated with his/her unique user ID associated with data provider 106b. The users represented in data provider 106b's set of user data can include users represented in data provider 106a's set of user data (i.e., there can be overlap between the users). In some situations, there is no overlap between users represented in data provider 106a's set of user data and data provider 106b's set of user data.

At stage 306, the sets of user data are analyzed (optionally) to determine if the user data shares a common format. For example, the data normalization system 202 can determine whether the sets of user data were normalized and formatted to conform to a common format before being transmitted to the data exchange system 102. In some implementations, the data normalization system 202 can compare the data attributes contained in each set of user data to determine whether the sets of user data share a common format. If the sets of user data conform to the common format, then the process continues to stage 310.

If the sets of user data do not share a common format, then associated rules are analyzed to determine if any rules have been created that can normalize the sets of user data (stage 307). In some implementations, the data normalization system 202 analyzes the data rules provided by data providers 106a and 106b and determines if any rules exist that relate to the data attributes represented in the sets of user data. For example, the sets of user data provided by data providers 106a and 106b can include user data related to deep sea fishing equipment. If neither data provider 106a nor data provider 106b specified a custom data model (e.g., created a rule that related to the data attributes such as related to deep sea fishing equipment), then the process 300 terminates. If the data normalization system 202 determines that a data rule that was created by either data provider 106a or 106b and that relates to the data attributes, the process will continue to stage 308. If no rule exists, the process 300 terminates.

At stage 308, the user data is transformed to conform to the data purchaser 108's custom data model. In some implementations, the data normalization system 202 can apply all the rules that are provided by the data providers 106a and 106b that are related to the user data in the sets of user data to normalize the user data. For example, the user data can be normalized such that the data attribute is given names specified by the data purchaser 106, such as “Price” or “Brand.” In addition, the user data can be normalized so the value conforms to a format specified by the data purchaser 106. In addition, the data normalization system 202 can restructure the user data. For example, the data normalization system 202 can restructure the normalized user data such that the user data is formatted according to the data provider's specifications. The data normalization system 202 can filter the user data so the transformed data includes only the specific data attributes that the data purchaser requested and/or puts the data in a specific order.

At stage 310, the sets of user data are analyzed and user clusters are identified. For example, after the two sets of user data are transformed such that they conform to the data purchaser's 108 custom data model, the clustering engine 204 can analyze the sets of user data and identify user clusters across the two sets. The clustering engine 204 can use various clustering algorithms, such as a k-means algorithm to identify the user clusters.

At stage 312, advertisement metric information is received and performance information is generated. For example, the performance model generator 206 can receive the user clusters and advertisement metric information, such as advertisement conversion rates, advertisement click through rates and/or advertisement interaction rates and use this information to determine performance information. The performance model generator 206 can determine performance information by, for example, using predictive modeling algorithms to predict how the user clusters will perform. The performance model generator 206 can predict how a user cluster will perform based on previously observed performance of similar or related user clusters, advertisement metric information and advertisement campaign information. For example, the performance model generator 206 can determine that a user cluster related to users searching for airfare to London will be valuable because previous user clusters related to users searching for airfare typically had high conversion rates and can suggest a price that the data purchaser 108 should pay for the user cluster. The performance model generator 208 can also calculate the data purchaser's return on its investment in the user clusters by analyzing the amount it paid for the user clusters and the conversion rate.

The performance model generator 206 can provide the performance information (e.g., the predictive model and the predicted return on investment) and other information such as the amount that the data providers 106 charged for their user clusters, the amount that the data purchaser 108 paid for the user clusters to the ad metric engine 112. The ad metric engine 112 can then provide feedback to both the data purchaser 108 and the data providers 106a regarding performance information and/or the value of the user clusters. The data purchaser 108 can use this feedback to adjust the money it is willing to pay for the clusters. The data providers 106a can use this information to adjust the amount of money it charges for the cluster information. For example, if the advertisements using data provider 106a's user cluster related to users interested in traveling to New York City have a high conversion rate, the ad metric engine 112 can provide this information to the data provider 106a, which allows the data provider 106a to increase the price of the user cluster.

The ad metric engine 112 can generate a report or some other form of feedback, such as of the form of an email message, that includes the predicted return on investment associated with the user clusters and information related to the price or value of the user cluster. For example, the ad metric engine 112 can receive predicted performance information that indicates a user cluster related to users shopping for large home appliances has a low conversion rate and suggest that the price of the user cluster should be low because of the low conversion rate and that a data purchaser should expect a low return on its investment in this data. Based on the feedback, the data providers 106 can adjust the pricing of the user clusters and the data purchasers 108 can adjust the amount it has offered to pay for the user clusters.

The user cluster and performance information is then output, or otherwise made accessible, to the data purchaser 108 (stage 314). In some implementations, the user cluster and the performance information is output, or made accessible, to the data purchaser 108 and/or the data providers 106a and 106b.

The data purchaser 108 can use the user clusters to personalize advertisements. For example, the data purchaser 108 can provide the user clusters to the advertisement network 110 and configure the advertisement network to show particular advertisements to members of the user cluster. The advertisement network 110 can determine that that user is a member of the user cluster by the user's unique user ID which is transmitted to the advertisement network 110 as the user browses or interacts with websites.

The data purchaser 108 can also use the user cluster to target advertisements at the members of the user clusters. For example, the data purchaser 108 can provide the user clusters to the advertisement network and instruct the advertisement network to display its advertisements to the members of the user clusters. In addition, the data purchaser 108 can use the user clusters and the performance information it has received to accurately determine how much it is willing to bid for advertisement placement.

In some implementations, the performance model generator 206 continuously receives advertisement metric information from the ad metric engine 112 and continuously updates the performance information (i.e., a continuous feedback loop). For example, as the data purchaser's advertisements using the user cluster are being displayed to users, the ad metric engine 112 collects data associated with the advertisements and the number of conversions. The advertisement metric information is continuously provided to the performance model generator 206, which updates its prediction model based on the updated advertisement performance information. The performance model generator 206 can update the data purchaser 108's calculated return on investment and can update the predicted value of the user clusters to give the data purchaser 108 and data providers 106a and 106b up-to-date guidance for the pricing of their data and the amount that should be paid for the data.

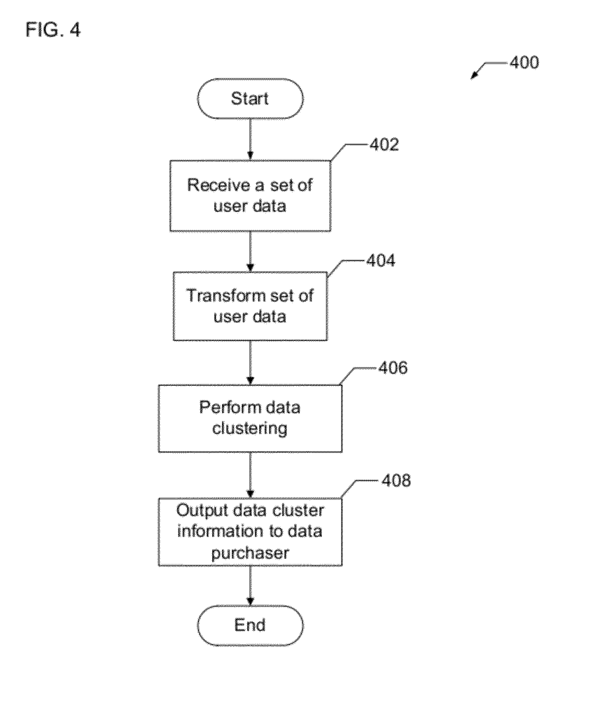

FIG. 4 is a flowchart of an example process for generating data clusters. The process 400 begins by receiving a set of user data (e.g., from data provider 106a) (stage 402). As described above, the set of user data includes user data associated with a plurality of users. Each user's user data is associated with his/her unique user ID and includes data collected by the data provider 106a from the users' interactions with the website.

In some implementations, the data provider 106a transmits user data as it is collected. The data exchange system 102 can store the user data in a database or memory and associate the user data with the data provider 106a. For example, the data exchange system 106a can use a descriptor or token to indicate that the user data was collected by the data provider 106a.

At stage 404, the user data is transformed as required to conform to the data purchaser's data model. The data normalization system 202 can transform the user data as described above in connection with stage 308. It is assumed that a rule exists to transform the set of user data to the data purchaser's data model. In some implementations, if a rule does not exist, the set of user data is not normalized and the user data is clustered using the data attributes provided by the data provider.

The set of user data is then analyzed to generate data clusters (stage 406). In some implementations, the clustering engine 204 analyzes the set of user data and identifies the co-occurrence of data attributes in each user's data across the set of user data to generate data clusters. For example, the clustering engine 204 can use various clustering algorithms to identify the data clusters, such as a k-means algorithm. If the set of user data includes a statistically significant number of users who expressed interest in a baseball bat and a baseball mitt, the clustering engine 204 can identify that the baseball bat is similar to or related to the baseball mitt. The data clusters are then provided to the data purchaser 108 and/or the data provider 106a (stage 408).

The data purchaser 108 can use the data cluster to generate recommendations to users that visit its website and express interest in a product or service contained in the data cluster. For example, if the data purchaser 108 received data clusters related to baseball equipment, a user shopping for a baseball bat on the data purchaser 108's website can be shown recommendations or suggestions that the user also purchase a baseball mitt. As another example, the data purchaser 108 can use a data cluster to suggest movies that the user may be interested in based on a movie the user recently viewed.

In addition, the data purchaser 108 can use the data clusters to optimize its online advertisements. For example, the data purchaser 108 can use a data cluster to personalize advertisements shown to a user. Based on the data cluster information, the data purchaser 108 can instruct the advertisement network 110 to display advertisements for products that are in the same data cluster as a product the user recently expressed interest in.

In some implementations, a process begins by receiving a first set of user data. The first set of user data is collected by the data provider 106a and transmitted to the data exchange system 202. A second set of user data is then transmitted to the data exchange system 202 by the data provider 106b. User cluster information is then generated based on common data attributes associated with the first and second sets of user data.

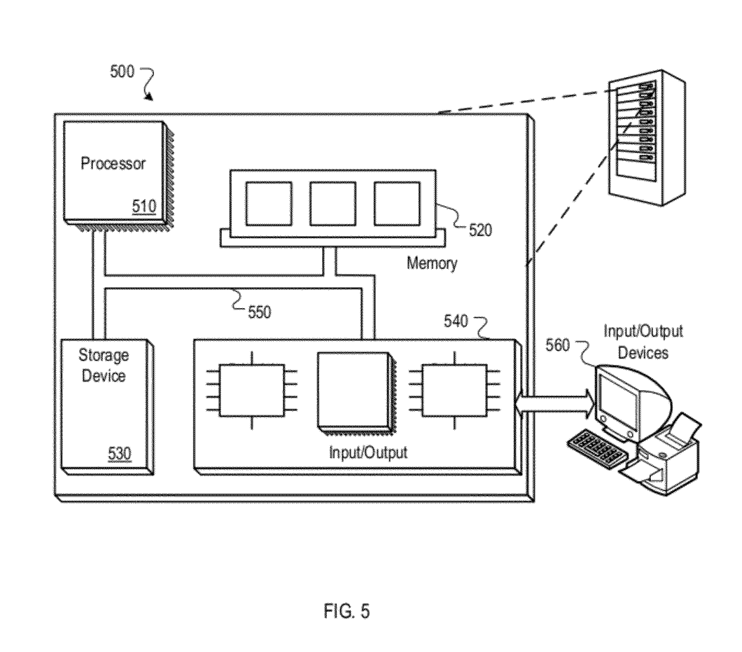

FIG. 5 is block diagram of an example computer system 500 that can be used to implement the data exchange system 102. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The various functions of the data exchange system 102 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The data exchange system 102 can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of embodiments of the invention have been described. In some cases, the actions recited in the claims can be performed in a different order and still achieve desirable results. In addition, the processes depicted in the accompanying figures do not necessarily require the particular order shown, or sequential order, to achieve desirable results. Nevertheless, it will be understood that various modifications may be made without departing from the spirit and scope of the invention. For example, the clustering engine 204 can be configured to receive user lists that are provided by the data providers 106a and 106b or generated by the data normalization system 202 and analyze the user lists to determine if the user lists are similar. The clustering engine 204 can analyze the members of the user lists and determine if there is an overlap of members, which would indicate that the two user lists are similar. For example, if data provider 106a provides a user list for users that searched for hotels in New York City (“NYC hotel user list”) and data provider 106b provides a user list for users that searched for New York City guidebooks (“NYC guidebook user list), then the clustering engine 202 can analyze the user IDs represented in each user list and determine if there are users that are members of both user lists. If the number of users in both lists is above a predetermined threshold, then the clustering engine 204 would identify the NYC guidebook list as being similar to the NYC hotel user list. The predetermined threshold can be decided by the data purchaser 108, the data providers 106a and 106b or the clustering engine 204.

The clustering engine 204 can apply other algorithms to identify similar user lists. In some implementations, the clustering engine 204 can apply a rule based algorithm that specifies when two user lists should be identified as being similar. For example, assuming there is a user list related to users searching for rental cars in major cities and a user list related to users searching for hotels in major metropolitan areas, the clustering engine 204 can apply a rule that identifies user lists with matching destinations and dates of travel as being similar user lists.

The data exchange system 102 can provide the similar user lists to data purchaser 108 and/or the data providers 106a and 106b. For example, if a data purchaser 108 expressed interest in purchasing the NYC hotel user list, the data exchange system 102 can identify NYC guidebook user list as a related list that serves the same target audience. The data purchaser 108 can then purchase both user lists and instruct the advertisement network 110 to target its advertisements at the members of both lists. Accordingly, other embodiments are within the scope of the following claims.

Although a few implementations have been described in detail above, other modifications are possible. Moreover, other mechanisms for clustering user data and providing performance information can be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method, the method comprising:
receiving a first data set associated with a first data provider, wherein the first data set comprises a first set of data attributes associated with a first set of users;
receiving a second data set associated with a second different data provider, wherein the second data set comprises a second set of data attributes associated with a second set of users;
generating user cluster information based at least in part on at least one common data attribute associated with the first set of users and the second set of users; and
providing the user cluster information to a data purchaser.

2. The computer implemented method of claim 1 further comprising transforming the first and second data sets to a common format before generating the user cluster information.

3. The computer implemented method of claim 1 wherein the user cluster information is used for performance analysis and reporting.

4. The computer implemented method of claim 1 wherein the user cluster information is used for advertisement bidding.

5. The computer implemented method of claim 1 wherein the user cluster information is used for advertisement targeting.

6. The computer implemented method of claim 1 wherein the user cluster information is used for advertisement personalization.

7. The computer implemented method of claim 1 further comprising:
receiving advertisement metric information, wherein the advertisement metric information comprises advertisement conversion rates, advertisement click through rates or advertisement interaction rates; and
generating performance information including using a predictive model derived from the advertisement metric information and the user cluster information.

8. The computer implemented method of claim 7 further comprising:
providing the performance information to the data purchaser, wherein the performance information comprises guidance as to a value of the user cluster information.

9. The computer implemented method of claim 7 wherein the predictive model uses previously observed data associated with second user cluster information, wherein the second user cluster information is similar to the user cluster information.

10. The computer implemented method of claim 7 wherein the performance information is used by the data purchaser to determine advertising pricing.

11. The computer implemented method of claim 7 wherein the user cluster information and the performance information is used to determine advertisement pricing.

12. The computer implemented method of claim 1 wherein the at least one common data attribute associated with the first set of users and the second set of users is determined by at least one of the first and second data providers and the data purchaser.

13. The computer implemented method of claim 1 wherein generating the user cluster information is also based on a weight associated with each of the at least one common data attribute associated with the first set of users and the second set of users.

14. The computer implemented method of claim 13 wherein the weight associated with the at least one common data attribute associated with the first set of users and the second set of users is determined by at least one of the first data provider, the second data provider or the data purchaser.

15. The computer implemented method of claim 2 further comprising
generating a second user cluster information based at least in part on at least one common data attribute associated with the first set of users; and
providing the second user cluster information to the data purchaser.

16. The computer implemented method of claim 1 wherein the data attributes associated with the first set of users comprises information associated with the user's activities on a website, information inherently collected from the website, or user's interactions with advertising and the second set of data attributes associated with the second set of users comprises information associated with the user's activities on a second website, information inherently collected from the second website, and/or user's interactions with advertising.

17. A computer-implemented method, the method comprising:
receiving a first user list associated with a first data provider, wherein the first user list comprises a plurality of users associated with a first set of data attributes
receiving a second user list associated with a second different data provider, wherein the second user list comprises a plurality of users associated with a second set of data attributes;
determining whether the first user list is similar to the second user list; and
identifying the second user list as similar to the first user list if the first user list is similar to the second user list including attributing known performance data associated with the first user list to the second user list.

18. The computer-implemented method of claim 16 wherein determining whether the first user list is similar to the second user list comprises determining whether the first and second user lists include common users.

19. The computer-implemented method of claim 16 wherein determining whether the first user list is similar to the second user list comprises applying a rule based algorithm to determine whether the first user list is similar to the second user list.

20. The computer-implemented method of claim 16 wherein the second user list is identified as similar to the first user list in response to a request for the first user list from a data purchaser.

21. A computer-implemented method, the method comprising:
receiving user data associated with a data provider, wherein the user data comprises a first data set associated with a first user and a second data set associated with a second user; and
generating data cluster information based on the co-occurrence of data in the first data set and the second data set.

22. The computer-implemented method of claim 21 further comprising:
transforming the user data from a first format to a second format, wherein the second format is defined by a data purchaser.

23. The computer-implemented method of claim 21 further comprising providing the data cluster information to at least one of a data purchaser or data provider.

24. The computer-implemented method of claim 21 wherein the data cluster information is used to generate a recommendation.

25. The computer-implemented method of claim 21 wherein the data cluster information is used for advertisement targeting.

26. The computer-implemented method of claim 21 wherein the data cluster information is used for advertisement personalization.

27. The computer-implemented method of claim 21 wherein the data cluster information is used for performance analysis and reporting.

28. The computer-implemented method of claim 21 wherein the data cluster information is used to determine a bid price for advertising.

29. The computer-implemented method of claim 21 wherein generating the data cluster information comprises applying a rule based clustering algorithm.

30. The computer-implemented method of claim 21 wherein generating the data cluster information comprises applying a machine learning based clustering algorithm.

31. A system, comprising:
a data normalization engine configured to receive a first data set associated with a first data provider and a second data set associated with a second different data provider and transform the first and second data set to a common format,
wherein the first data set comprises a first set of data attributes associated with a first set of users,
wherein the second data set comprises a second set of data attributes associated with a second set of users; and
a clustering engine connected to the data normalization engine, wherein the clustering engine is configured to generate user cluster information based on at least one common data attribute associated with the first set of users and the second set of users.

32. The system of claim 31 further comprising:
a performance model generator configured to receive advertisement metric information and generate performance information including using a predictive model derived from the advertisement metric information and the user cluster information, wherein the advertisement metric information comprises advertisement conversion rates, advertisement click through rates or advertisement interaction rates.

33. A computer readable medium encoded with a computer program comprising instructions that, when executed, operate to cause a computer to perform operations:
receive a first data set associated with a first data provider, wherein the first data set comprises a first set of data attributes associated with a first set of users;
receive a second data set associated with a second different data provider, wherein the second data set comprises a second set of data attributes associated with a second set of users;
generate user cluster information based on at least one common data attribute associated with the first set of users and the second set of users; and
provide the user cluster information to a data purchaser.

34. The computer readable medium of claim 33, further comprising instructions that when executed cause the computer to perform operations:
receive advertisement metric information, wherein the advertisement metric information comprises advertisement conversion rates, advertisement click through rates or advertisement interaction rates;
generate performance information including using a predictive model derived from the advertisement metric information and the user cluster information; and
provide the performance information to the data purchaser, wherein the performance information comprises guidance as to the value of the user cluster information.
